(19) United States
(12) Patent Application Publication
(10) Pub. No.: US 2026/0004619 A1
(43) Pub. Date: Jan. 1, 2026

(54) INFORMATION PROCESSING SYSTEM, CONTROL METHOD OF INFORMATION PROCESSING SYSTEM, AND STORAGE MEDIUM

(71) Applicant: HONDA MOTOR CO., LTD., Tokyo (JP)

(72) Inventors: Shun FUJII, Tokyo (JP); Daisuke SAITO, Tokyo (JP)

(21) Appl. No.: 19/210,257

(22) Filed: May 16, 2025

(30) Foreign Application Priority Data
Jun. 27, 2024 (JP) 2024-104328

(51) Int. Cl. G07C 5/08; B60Q 5/00; B60Q 9/00

(52) U.S. Cl. CPC G07C 5/0808; B60Q 9/00; B60Q 5/005

(57) ABSTRACT

An information processing system configured to detect tampering of vehicle data, the information processing system comprising: a vehicle data acquisition unit configured to acquire first vehicle data and second vehicle data; a first tampering detection unit configured to detect a tampering possibility of the vehicle data, based on the first vehicle data and the second vehicle data; and a second tampering detection unit configured to detect tampering of the first vehicle data, based on first evaluation data for evaluating the first vehicle data, and also configured to detect tampering of the second vehicle data, based on second evaluation data for evaluating the second vehicle data, in a case where the first tampering detection unit detects that there is the tampering possibility.

### CROSS-REFERENCE TO RELATED APPLICATION(S)

This application claims priority to and the benefit of Japanese Patent Application No. 2024-104328, filed Jun. 27, 2024, the entire disclosure of which is incorporated herein by reference.

### BACKGROUND OF THE INVENTION

### Field of the Invention

The present invention relates to an information processing system, a control method of the information processing system, and a storage medium, and particularly relates to a technique for detecting tampering of vehicle data.

### Description of the Related Art

Japanese Patent Laid-Open No. 2012-126273 discloses calculating a first vehicle speed V1 corresponding to a pulse signal proportional to a rotation speed of a drive wheel 12 output from a vehicle speed sensor 14, calculating a second vehicle speed V2 from a change in vehicle location measured by a GPS receiver 16 or an output signal of the GPS receiver 16, and determining whether a vehicle speed signal (the first vehicle speed V1) has been tampered with, based on a comparison between the first vehicle speed V1 and the second vehicle speed V2.

In the technique described in Japanese Patent Laid-Open No. 2012-126273, however, it is assumed that the second vehicle speed V2 is a correct value, but in a case where the second vehicle speed V2 has been tampered with, it is impossible to determine whether the first vehicle speed V1 is correct. In this manner, Japanese Patent Laid-Open No. 2012-126273 has a problem that it is difficult to correctly determine either one of the two signals to be compared with each other has been tampered with.

### SUMMARY OF THE INVENTION

The present invention has been made in view of the above problems, and provides a technique for accurately detecting tampering of vehicle data. In addition, the present application enhances the safety of passengers, further improves traffic safety, and contributes to development of a sustainable transportation system, accordingly.

According to one aspect of the present invention, there is provided an information processing system configured to detect tampering of vehicle data, the information processing system comprising: a vehicle data acquisition unit configured to acquire first vehicle data and second vehicle data; a first tampering detection unit configured to detect a tampering possibility of the vehicle data, based on the first vehicle data and the second vehicle data; and a second tampering detection unit configured to detect tampering of the first vehicle data, based on first evaluation data for evaluating the first vehicle data, and also configured to detect tampering of the second vehicle data, based on second evaluation data for evaluating the second vehicle data, in a case where the first tampering detection unit detects that there is the tampering possibility.

### BRIEF DESCRIPTION OF THE DRAWINGS

FIG. 1 is a block diagram of a vehicle and a control device according to one embodiment;

FIG. 2 is a diagram illustrating a configuration example of an information processing system according to one embodiment;

FIG. 3 is a diagram illustrating a hardware configuration example of the information processing apparatus according to one embodiment;

FIG. 4 is a diagram illustrating an example of a functional configuration of the control device included in the vehicle according to one embodiment;

FIG. 5 is a diagram illustrating an example of a functional configuration of an information processing apparatus according to one embodiment;

FIG. 6 is a processing sequence diagram of the information processing system according to one embodiment;

FIG. 7 is an explanatory diagram of a relationship among a turning radius, a wheelbase, and a tire steering angle of the vehicle according to one embodiment;

FIG. 8 is an explanatory diagram of a motor regenerative torque allocatable upper limit value and a motor regenerative torque allocation value according to one embodiment;

FIG. 9 is an explanatory diagram of a tampering pattern of the motor regenerative torque allocation value according to one embodiment;

FIG. 10 is a diagram illustrating an example of vehicle data and its evaluation data according to one embodiment;

FIG. 11 is a diagram illustrating an example of the vehicle data and its evaluation data according to one embodiment;

FIG. 12 is a diagram illustrating an example of the vehicle data and its evaluation data according to one embodiment;

FIG. 13 is an explanatory diagram of an example of simple tampering detection processing according to one embodiment; and

FIG. 14 is an explanatory diagram of an example of detailed tampering detection processing according to one embodiment.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### Embodiments

In a device equipped with a sensor or an actuator, there is a possibility that a measurement value or a command value might be tampered with by cyberattack. However, if a value is tampered with and becomes outside a design value range, it would be possible to find such a value in normal failure detection processing. For example, when the vehicle speed indicates a value exceeding the maximum speed of the vehicle, it is possible to determine that a failure is apparently occurring.

In a case where a large change in value occurs within the design value range, however, it is not possible to find it in the normal failure detection. For example, even though the actual vehicle speed is 50 km/h, in a case where the actual vehicle speed of 80 km/h is indicated after having been tampered with by adding 30 km/h, such a case is tampering within a range that could be as the vehicle speed. Therefore, it is difficult to detect the tampering in the normal failure detection processing. Nevertheless, there is a possibility that a large change in value within the design value range might lead to a serious situation. For this reason, there is a demand for detecting a large change in value within the design value. In the present embodiment, even though such a large change in value within the design value range occurs, an example of detecting the tampering will be described.

### <Control Device and its Application Example>

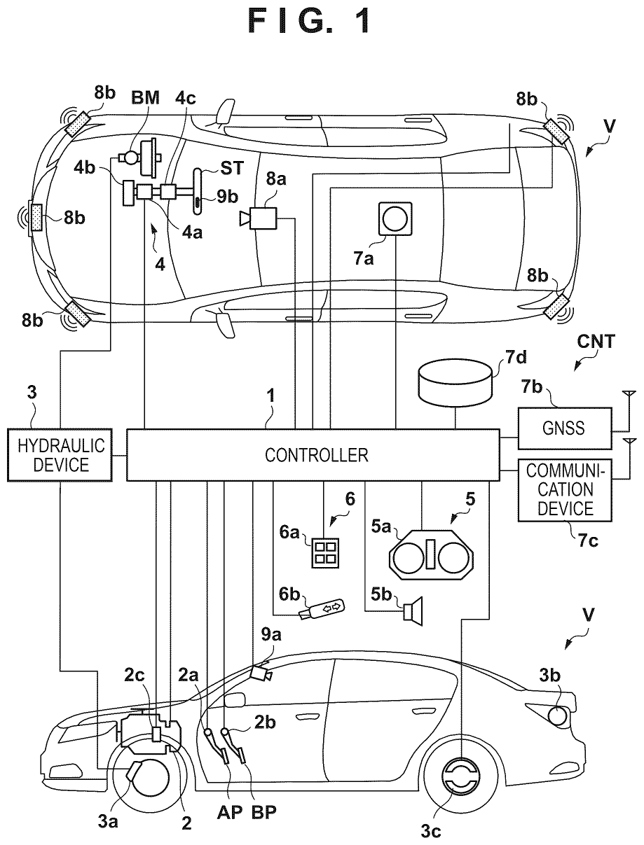

FIG. 1 is a block diagram of a control device CNT according to one embodiment, and is a schematic diagram of a vehicle V, which is its application example. In FIG. 1, an outline of the vehicle V is illustrated in a plan view and a side view. The vehicle V according to the present embodiment is, for example, a sedan-type four-wheeled passenger vehicle, and may be, for example, a parallel hybrid vehicle. Note that the vehicle V is not limited to the four-wheeled passenger vehicle, and may be a straddle type vehicle (motorcycle, three-wheeled vehicle) or a large vehicle such as a truck or a bus.

The control device CNT includes a controller 1, which is an electronic circuit that controls the vehicle V, including driving assistance of the vehicle V. The controller 1 includes a plurality of electronic control units (ECUs). For example, an ECU is provided for every function of the control device CNT. Each ECU includes a processor represented by a central processing unit (CPU), a storage device such as a semiconductor memory, an interface with an external device, and the like. The storage device stores a program to be executed by the processor, data used for processing on the processor, and the like. The interface includes an input and output interface and a communication interface. Each ECU may include a plurality of processors, a plurality of storage devices, and a plurality of interfaces. A program to be stored in the storage device may be installed in the control device CNT using a storage medium such as a CD-ROM, and thus may be stored in the storage device.

The controller 1 controls driving (acceleration) of the vehicle V by controlling a power unit (power plant) 2. The power unit 2 is a travel driving unit that outputs driving force for rotating drive wheels of the vehicle V and can include an internal combustion engine, a motor, and an automatic transmission. The motor can be used as a drive source for accelerating the vehicle V, and can also be used as a generator at the time of deceleration or the like (regenerative braking).

In the present embodiment, the controller 1 controls the outputs of the internal combustion engine and the motor and switches the gear range of the automatic transmission, for example, in response to driver's driving operation that has been detected by an operation sensor 2a, which is provided in an accelerator pedal AP, and by an operation sensor 2b, which is provided in a brake pedal BP, and in accordance with a speed of the vehicle V that has been detected by a rotation speed sensor 2c. Note that the rotation speed sensor 2c, which detects the rotation speed of an output shaft of the automatic transmission, is provided on the automatic transmission, as a sensor for detecting a traveling state of the vehicle V. The vehicle speed of the vehicle V can be calculated from a detection result of the rotation speed sensor 2c.

The controller 1 controls braking (deceleration) of the vehicle V by controlling a hydraulic device 3. A driver's braking operation on the brake pedal BP is converted into hydraulic pressure in a brake master cylinder BM, and is transmitted to the hydraulic device 3. The hydraulic device 3 is an actuator capable of controlling the hydraulic pressure of hydraulic oil supplied to a brake device 3a (for example, a disc brake device), which is provided on each of four wheels, based on the hydraulic pressure transmitted from the brake master cylinder BM.

The controller 1 is capable of controlling braking of the vehicle V, by performing drive control of an electromagnetic valve or the like included in the hydraulic device 3. In addition, the controller 1 is also capable of configuring an electric servo brake system, by controlling the distribution of the braking force by the brake device 3a and the braking force by the regenerative braking of the motor included in the power unit 2. The controller 1 may turn on a brake lamp 3b at the time of braking.

The controller 1 controls the steering of the vehicle V by controlling an electric power steering device 4. The electric power steering device 4 includes a mechanism for steering front wheels in response to a driver's drive operation (steering operation) on a steering wheel ST. The electric power steering device 4 includes a drive unit 4a, which exerts driving force (referred to as steering assist torque, in some cases) for assisting in the steering operation or automatic steering of the front wheels of the vehicle V. The drive unit 4a includes a motor as a drive source. Further, the electric power steering device 4 includes a steering angle sensor 4b, which detects a steering angle, and a torque sensor 4c, which detects steering torque (referred to as steering load torque to be distinguished from steering assist torque) applied by the driver.

The controller 1 controls electric parking brake devices 3c, which is provided on the rear wheels of the vehicle V, respectively. The electric parking brake device 3c includes a mechanism for locking the rear wheel. The controller 1 is capable of controlling the locking and unlocking of the rear wheel with the electric parking brake device 3c.

The controller 1 controls an information output device 5, which notifies the inside of the vehicle of information. The information output device 5 includes, for example, a display device 5a, which notifies the driver of information with an image, and/or a sound output device 5b, which notifies the driver of information with sound. Examples of the display device 5a include a display device provided in an instrument panel and a display device provided in the steering wheel ST. In addition, the display device 5a may include a head-up display. The information output device 5 may notify the occupant of information using vibration or light.

The controller 1 receives an instruction input by the occupant (for example, the driver) via an input device 6. The input device 6 is disposed at a position operable by the driver, and includes, for example, a switch group 6a, which is used for the driver to instruct the vehicle V and/or a blinker lever 6b, which actuates a direction indicator (blinker).

The controller 1 recognizes and determines a current location and a course (attitude) of the vehicle V. In the present embodiment, a gyro sensor 7a, a global navigation satellite system (GNSS) sensor 7b, and a communication device 7c are provided in the vehicle V. The gyro sensor 7a detects a rotational motion (yaw rate) of the vehicle V. The GNSS sensor 7b detects the current location of the vehicle V. In addition, the communication device 7c wirelessly communicates with a server for providing map information and traffic information, and acquires such pieces of information. In the present embodiment, the controller 1 determines the course of the vehicle V, based on detection results of the gyro sensor 7a and the GNSS sensor 7b, also acquires map information about the course from the server sequentially via the communication device 7c, and then stores the map information in a database 7d (storage device). Note that another sensor for detecting the state of the vehicle V, such as an acceleration sensor for detecting the acceleration of the vehicle V, may be provided in the vehicle V.

The controller 1 performs the driving assistance of the vehicle V, based on detection results of various detection units provided in the vehicle V. The vehicle V includes a plurality of surroundings detection units 8a and 8b, each of which is an external sensor that detects the outside (a surrounding situation) of the vehicle V, and a plurality of in-vehicle detection units 9a and 9b, each of which is an in-vehicle sensor that detects a state inside the vehicle (the states of occupants, particularly, the driver). The controller 1 is capable of grasping the surrounding situations of the vehicle V, based on the detection results of the surroundings detection units 8a and 8b, and then performing the driving assistance of the vehicle V in accordance with the surrounding situations. In addition, the controller 1 is capable of determining whether the driver is performing a predetermined operation obligation of the driver imposed when performing the driving assistance, based on the detection results of the in-vehicle detection units 9a to 9b.

The surroundings detection unit 8a is an imaging device (hereinafter, referred to as a front camera 8a, in some cases) that captures an image on a forward side of the vehicle V, and is attached to a vehicle interior of the windshield at a front part of the roof of the vehicle V, for example. The controller 1 analyzes an image that has been captured by the front camera 8a, and is capable of extracting a contour of a target object or a lane marking (such as a white line) on a road.

The surroundings detection unit 8b is a millimeter wave radar (hereinafter, referred to as a radar 8b, in some cases), detects a target object in the surroundings of the vehicle V using radio waves, and detects (measures) a distance to the target object and a direction (azimuth) to the target object with respect to the vehicle V. In the example illustrated in FIG. 1, five radars 8b are provided, one at the center of the front portion of the vehicle V, one at each of the left and right corner portions of the front portion, and one at each of the left and right corner portions of the rear portion.

Note that the surroundings detection unit provided in the vehicle V is not limited to the above configuration, and the number of cameras and the number of radars may be changed, or a light detection and ranging (LiDAR) for detecting a target object in the surroundings of the vehicle V may be provided.

The in-vehicle detection unit 9a is an imaging device (hereinafter, referred to as an in-vehicle camera 9a, in some cases) that captures an image of the inside of the vehicle, and is attached to the vehicle interior at the front part of the roof of the vehicle V, for example. In the present embodiment, the in-vehicle camera 9a is a driver monitor camera that captures an image of the driver (for example, driver's eyes and face). The controller 1 analyzes an image (an image of the driver's face) that has been captured by the in-vehicle camera 9a, and is capable of determining a driver's line of sight and a direction of a driver's face.

The vehicle interior detection unit 9b is a grip sensor (hereinafter, referred to as a grip sensor 9b, in some cases) that detects the driver's grip on the steering wheel ST, and is provided in at least a part of the steering wheel ST, for example. Note that as the vehicle interior detection unit, the torque sensor 4c, which detects the steering torque of the driver, may be used.

### <Configuration of Information Processing System>

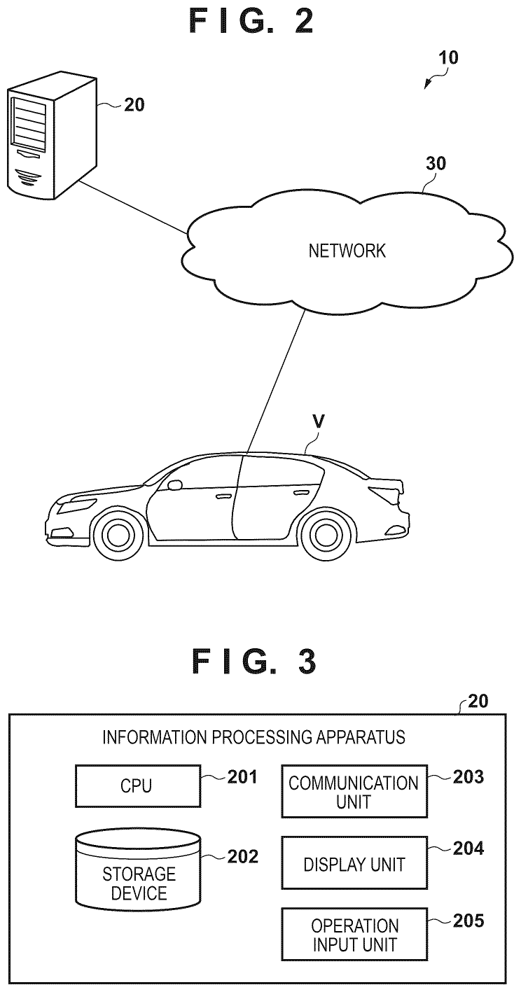

FIG. 2 is a diagram illustrating a configuration example of an information processing system according to one embodiment. An information processing system 10 includes an information processing apparatus 20 and a vehicle V, and detects tampering of vehicle data. The information processing apparatus 20 and the vehicle V are connected with each other through a network 30. The information processing apparatus 20 is a server apparatus outside the vehicle V, and includes, for example, a PC or the like. The information processing apparatus 20 is capable of performing various types of processing, based on information that has been acquired from the vehicle V. The network 30 is a network such as a WAN or LAN. The information processing apparatus 20 and the vehicle V are capable of communicating with each other in a wired and/or wireless manner through the network 30.

### <Hardware Configuration of Information Processing Apparatus>

Next, a hardware configuration example of the information processing apparatus 20 according to one embodiment will be described with reference to FIG. 3. As illustrated in FIG. 3, the information processing apparatus 20 includes a CPU 201, a storage device 202, a communication unit 203, a display unit 204, and an operation input unit 205. The control operation of the information processing apparatus 20 is achieved by the CPU 201 reading and executing a computer program stored in the storage device 202.

The CPU 201 may be one or more CPUs. The storage device 202 is one or more memories that store several types of information. For example, information that has been received from another apparatus, a computer program to be read and executed on the CPU 201, and the like are stored. The communication unit 203 has a function of communicating with another device in a wired and/or wireless manner through the network 30. In addition, the communication unit 203 may be capable of communicating with a nearby device by proximity wireless communication. The display unit 204 is a liquid crystal display or the like, and displays various types of information. The operation input unit 205 is, for example, a mouse, a keyboard, a touch panel, a switch, or the like, and is capable of receiving input of various types of information from a user.

### <Functional Configuration of Control Device CNT Included in Vehicle>

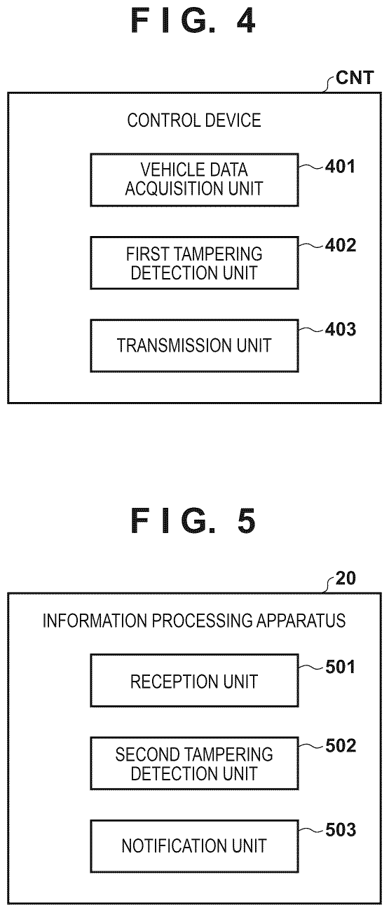

An example of a functional configuration of a control device CNT provided in a vehicle V according to one embodiment will be described with reference to FIG. 4. The control device CNT includes a vehicle data acquisition unit 401, a first tampering detection unit 402, and a transmission unit 403. Each function of the control device CNT is fulfilled by the ECU.

The vehicle data acquisition unit 401 acquires various types of vehicle data that have been measured and/or calculated by each sensor or the like of the vehicle V. Examples of the vehicle data include, but are not limited to, a transmission vehicle speed VT, a wheel speed VW, a YAW angular velocity, a motor regenerative torque allocation value, and a motor regenerative torque allocatable upper limit value. Note that details of each vehicle data will be described later.

The first tampering detection unit 402 detects that there is a possibility that the vehicle data has been tampered with, by using the vehicle data that has been acquired by the vehicle data acquisition unit 401. The first tampering detection unit 402 detects a tampering possibility in a relatively simple method, in contrast to a second tampering detection unit 502 to be described later. In the present embodiment, the tampering possibility of the vehicle data is detected, based on two pieces of vehicle data. The physical quantities of two pieces of vehicle data may be identical in type to each other. For example, the transmission vehicle speed VT and the wheel speed VW may be used. Alternatively, the YAW angular velocity and a comparison value (the same physical quantity with the YAW angular velocity) derived from vehicle data different from the YAW angular velocity may be used. Alternatively, a motor regenerative torque allocation value and a motor regenerative torque allocatable upper limit value may be used.

In a case where the first tampering detection unit 402 detects that there is a tampering possibility, the transmission unit 403 transmits logging data of the vehicle V including the vehicle data and evaluation data for evaluating the vehicle data to the information processing apparatus 20.

<First Tampering Detection Processing (Simple Detection processing)>

Here, the transmission vehicle speed VT denotes speed data of the vehicle V derived from measurement data related to the transmission, and is a vehicle speed calculated from the rotation speed of a motor shaft, a moving radius of a tire, and the like. It is possible to calculate the transmission vehicle speed VT in, for example, the following equation (1).

$$VT = ( 2 π \times tire moving radius \times 60 / 1000 ) \times ( FIN Dr / FIN Dn ) \times ( MOT Dr / MOT Dn ) \times rotation speed \qquad ( 1 )$$

Here, VT: transmission vehicle speed [km/h], tire moving radius [m], FIN Dr: final drive gear [teeth], and FIN Dn: final driven gear [teeth]. In addition, MOT Dr: motor drive gear [teeth], MOT Dn: motor driven gear [teeth], rotation speed (communication value) [rpm]. Further, a “final” gear means a gear finally connected to wheels, among a plurality of gears. According to the equation (1), it is possible to calculate the transmission vehicle speed VT using the rotation speed of the motor shaft as an input.

The wheel speed denotes a vehicle speed calculated from the rotation speed of the wheel, a circumferential length of the wheel, and the like. As the wheel speed, for example, an average value of the left and right front wheels may be used. This makes it possible to reduce an influence of the speed difference between the left and right wheels. As the rotation speed of the wheel, a value of a sensor provided on each wheel may be acquired.

In a case where the vehicle data includes the transmission vehicle speed and the wheel speed, the first tampering detection unit 402 determines whether an absolute value of a difference between the transmission vehicle speed and the wheel speed is equal to or larger than a threshold (for example, 20 km/h). In a case where the absolute value of the difference is equal to or larger than the threshold, it is determined that there is a possibility that either the transmission vehicle speed or the wheel speed has been tampered with. Accordingly, it becomes possible to detect a tampering possibility, even though a large change in value occurs within a design value range that cannot be found in the normal failure detection.

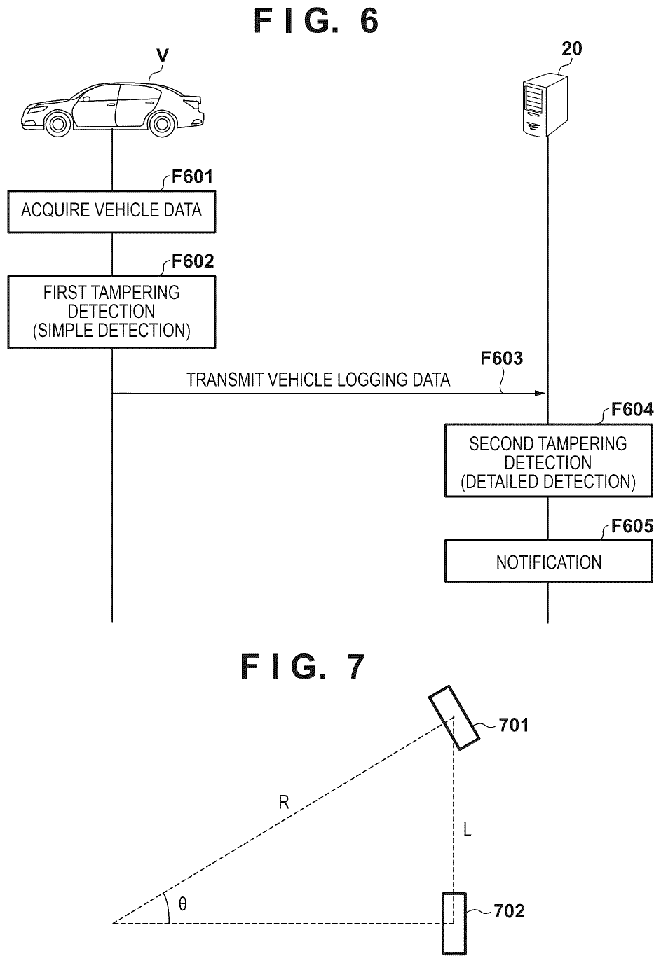

Next, the YAW angular velocity ω indicates a change amount of the YAW angle per unit time. As illustrated in FIG. 7, since sin(θ)=L/R, the YAW angular velocity ω is calculated in, for example, the following equation (2).

$$ω = V / R = V \times \{ sin ( θ ) / L \} \qquad ( 2 )$$

Here, YAW angular velocity: ω [rad], vehicle speed: V [m/s], lateral G: a [m/s²], turning radius of the vehicle: R (rad), wheelbase: L [m], and tire steering angle: θ [rad]. In addition, ω2 is calculated in the following equation (3).

$${ω}^{2} = a / R = a \times \{ sin ( θ ) / L \} \qquad ( 3 )$$

In a case where the vehicle data includes the YAW angular velocity ω and its comparison values, the first tampering detection unit 402 determines whether both conditions that the difference between the YAW angular velocity and a comparison value 1 is equal to or larger than a threshold value (for example, 5.5 deg/s) and the difference between the square of the YAW angular velocity and a comparison value 2 is equal to or larger than a threshold value (for example, 5.52 deg²/s²) are satisfied.

In a case where both conditions are satisfied, it is determined that there is a possibility that the YAW angular velocity ω has been tampered with.

Here, the comparison value 1 and the comparison value 2 are respectively calculated from the following equations (4) and (5).

$$Comparison value 1 [ deg / s ] = drive motor rotation direction \times \{ wheel speed [ m / s ] / rotation radius [ m ] \} \times ( 180 / π ) \qquad ( 4 )$$

$$Comparison value {2 [ deg / s ]}^{2} = \{ lateral acceleration [ m / {s}^{2} ] / rotation radius [ m ] \} \times {( 180 / π )}^{2} \qquad ( 5 )$$

In addition, the rotation radius in the equations (4) and (5) is calculated in the following equation (6).

$$Rotation radius [ m ] = wheelbase [ m ] \times sin \{ ratio of steering angle to tire angle \times ( π / 180 ) \times steering angle [ deg ] ) \qquad ( 6 )$$

For the wheel speed, the lateral acceleration, and the steering angle in the equations (4) to (6), values acquired as the vehicle data are respectively used.

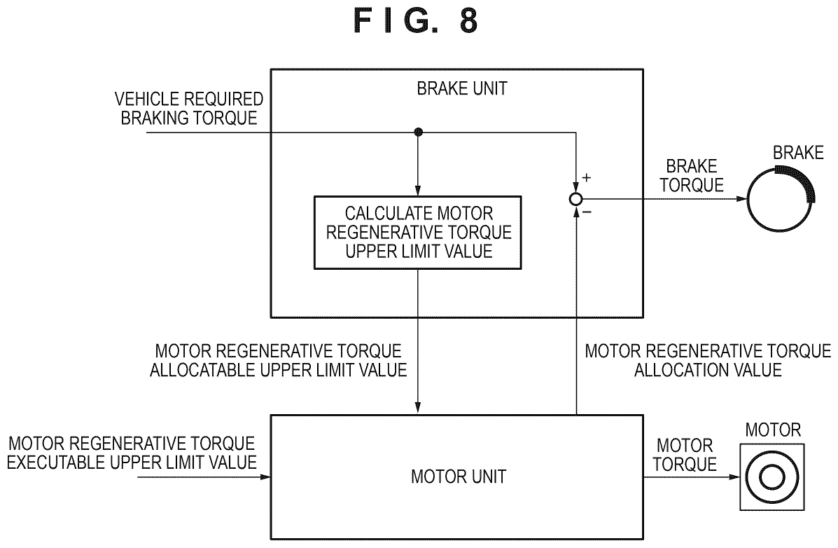

Next, the motor regenerative torque allocation value denotes torque for subtracting the braking torque corresponding to the regeneration of the motor from the brake. The motor regenerative torque allocatable upper limit value denotes torque that can subtract the braking torque from the brake, and normally satisfies a relationship of “the motor regenerative torque allocatable upper limit value>the motor regenerative torque allocation value”. As illustrated in FIG. 8, the motor regenerative torque allocatable upper limit value is calculated from vehicle required braking torque. Then, the motor torque and the motor regenerative torque allocation value are calculated from a motor regenerative torque executable upper limit value and the motor regenerative torque allocatable upper limit value. The brake torque is generated by subtracting the motor regenerative torque allocation value from the vehicle required braking torque.

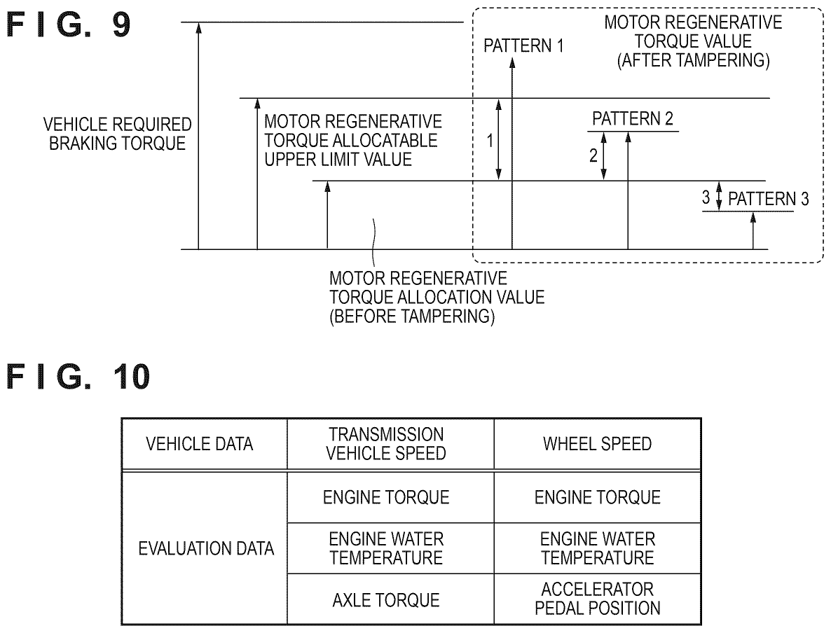

As illustrated in FIG. 9, in a case where the motor regenerative torque allocation value is tampered with like a pattern 1, the torque indicated by “1” is unnecessarily subtracted, and thus the effect of braking is degraded. In a case where the motor regenerative torque allocation value is tampered with like a pattern 2, the torque indicated by “2” is unnecessarily subtracted, and thus the effect of braking is slightly degraded. In a case where the motor regenerative torque allocation value is tampered with like a pattern 3, the torque indicated by “3” is unnecessarily added, and thus the effect of braking is slightly too enough. Here, when “the motor regenerative torque allocatable upper limit value<the motor regenerative torque allocation value” is satisfied, it is possible to detect tampering of the pattern 1. On the other hand, although it is not possible to detect the tampering of the pattern 2 or the pattern 3, the influence on the vehicle is relatively small.

In a case where the vehicle data includes the motor regenerative torque allocation value and the motor regenerative torque allocatable upper limit value, the first tampering detection unit 402 determines whether “the motor regenerative torque allocatable upper limit value<the motor regenerative torque allocation value” is satisfied. In a case where “the motor regenerative torque allocatable upper limit value<the motor regenerative torque allocation value” is satisfied, it is determined that there is a possibility that the motor regenerative torque allocation value has been tampered with.

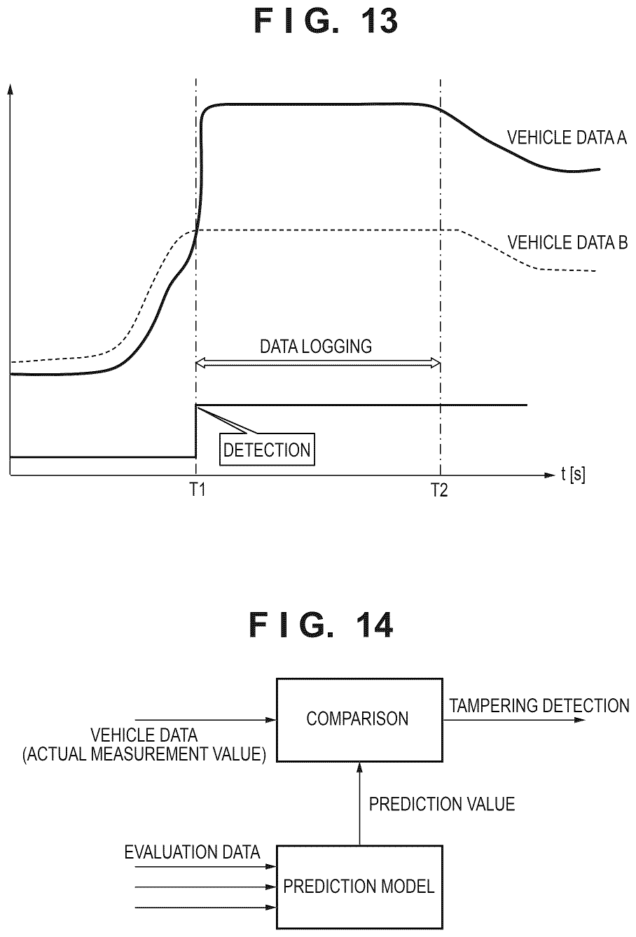

Here, FIG. 13 is an explanatory diagram of an example of first tampering detection processing according to the present embodiment. The first tampering detection unit 402 of the control device CNT of the vehicle V acquires two pieces of vehicle data (vehicle data A and vehicle data B), and detects a tampering possibility of the vehicle data from its change. Here, the vehicle data A is the motor regenerative torque allocation value, and the vehicle data B is the motor regenerative torque allocatable upper limit value. As described above, in the case where the vehicle data is not tampered with, the relationship of “the motor regenerative torque allocatable upper limit value (the vehicle data B)>the motor regenerative torque allocation value (the vehicle data A)” is satisfied.

Before time T1, the relationship of “the motor regenerative torque allocatable upper limit value (the vehicle data B)>the motor regenerative torque allocation value (the vehicle data A)” is maintained, and no data is tampered with. However, “the motor regenerative torque allocatable upper limit value (the vehicle data B)<the motor regenerative torque allocation value (the vehicle data A)” is satisfied at time T1, and it is detected that there is the tampering possibility (simple tampering detection).

### <Example of Evaluation Data>

Next, an example of the evaluation data will be described. The evaluation data is data for evaluating the vehicle data, and the physical quantity of the vehicle data may be a physical quantity different in type from the physical quantity of the evaluation data. By inputting one or more pieces of evaluation data into a learned prediction model beforehand, vehicle data that has been predicted and calculated (a prediction value) is acquired.

In a case where the vehicle data includes the transmission vehicle speed and the wheel speed, the evaluation data for evaluating the transmission vehicle speed may include engine torque, an engine water temperature, and axle torque, as illustrated in FIG. 10. In addition, the evaluation data for evaluating the wheel speed may include the engine torque, the engine water temperature, and an accelerator pedal position.

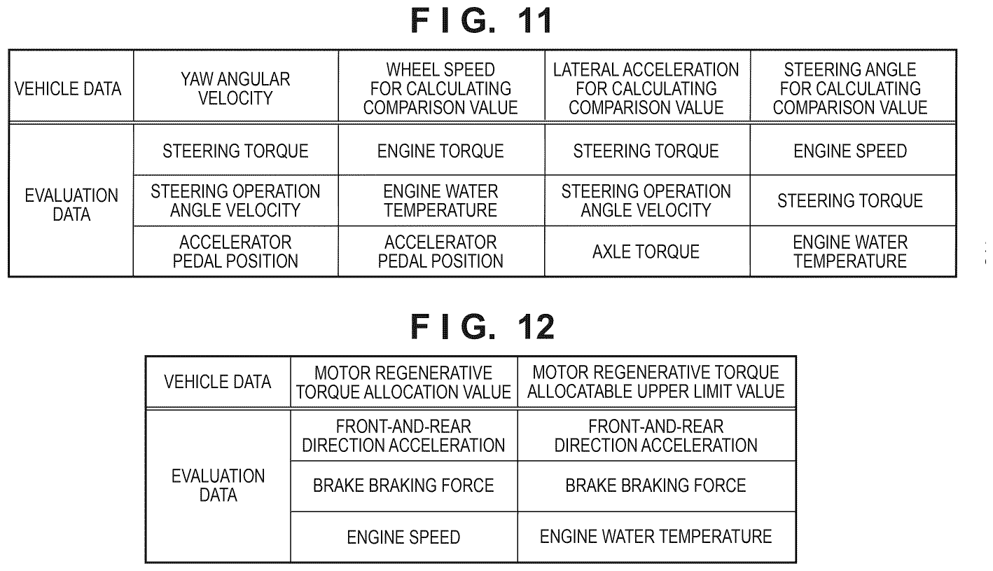

In a case where the vehicle data includes the YAW angular velocity and its comparison values, the evaluation data for evaluating the YAW angular velocity may include the steering torque, steering angular velocity, and the accelerator pedal position, as illustrated in FIG. 11. The YAW angular velocity is compared with the comparison value 1 and the comparison value 2 as described above, but the wheel speed and the steering angle are used for calculating the comparison value 1, and the lateral acceleration and the steering angle are used for calculating the comparison value 2.

The evaluation data for evaluating the wheel speed may include the engine torque, the engine water temperature, and the accelerator pedal position. The evaluation data for evaluating the lateral acceleration may include the steering torque, the steering angular velocity, and the axle torque. The evaluation data for evaluating the steering angle may include the engine speed, the steering torque, and the engine water temperature.

In a case where the vehicle data includes the motor regenerative torque allocation value and the motor regenerative torque allocatable upper limit value, the evaluation data for evaluating the motor regenerative torque allocation value may include front-and-rear direction acceleration, braking force of the brake, and the engine speed, as illustrated in FIG. 12. In addition, evaluation data for evaluating the motor regenerative torque allocatable upper limit value may include the front-and-rear direction acceleration, the braking force of the brake, and the engine water temperature.

In the example of FIG. 13, since the tampering possibility is detected at time T1, the data logging is made for a certain period of time from time T1 to time T2. The logging data acquired here includes the motor regenerative torque allocation value and the motor regenerative torque allocatable upper limit value, which are the vehicle data. In addition, the logging data includes the front-and-rear direction acceleration, the braking force of the brake, and the engine speed, which are included in the evaluation data for evaluating the motor regenerative torque allocation value, and the front-and-rear direction acceleration, the braking force of the brake, and the engine water temperature, which are included in the evaluation data for evaluating the motor regenerative torque allocatable upper limit value.

### <Configuration of Information Processing Apparatus>

Next, an example of a functional configuration of an information processing apparatus according to one embodiment will be described with reference to FIG. 5. The information processing apparatus 20 includes a reception unit 501, the second tampering detection unit 502, and a notification unit 503. Each function of the information processing apparatus 20 is fulfilled by the CPU 201.

The reception unit 501 receives the logging data transmitted from the transmission unit 403 of the control device CNT of the vehicle V. The logging data includes the vehicle data and the evaluation data for evaluating the vehicle data. When the logging data is received by the reception unit 501, there is a tampering possibility of the vehicle data. Thus, the second tampering detection unit 502 performs detailed tampering detection processing of detecting tampering of the vehicle data, based on the evaluation data. Specifically, as illustrated in FIG. 14, by inputting one or more pieces of evaluation data into a prediction model (for example, a machine-learned model), a prediction value of corresponding vehicle data is output. Then, such a prediction value is compared with vehicle data that is an actual measurement value to determine whether the vehicle data has been tampered with. For example, in a case where the actual measurement value has a difference equal to or larger than a threshold from the prediction value, it may be determined that the vehicle data has been tampered with. Regarding the prediction model, various prediction models have been learned and prepared beforehand for every set of evaluation data to be input.

When the second tampering detection unit 502 detects the tampering, the notification unit 503 notifies of the fact. In a case where the information processing apparatus 20 is a PC, such a notification may be given by displaying on the display unit 204, or may be given by outputting a warning sound of a speaker. Alternatively, a combination of them may be used. Alternatively, the notification unit 503 may transmit a warning to the vehicle V, and the vehicle V may notify of an occurrence of tampering (display and/or output a warning sound).

### <Second Tampering Detection Processing (Detailed Detection Processing)>

A case where the vehicle data includes the transmission vehicle speed and the wheel speed will be described. First, the second tampering detection unit 502 inputs the respective values of the engine torque, the engine water temperature, and the axle torque, which are included in the evaluation data for evaluating the transmission vehicle speed, into a prediction model beforehand, and acquires a prediction value of the transmission vehicle speed. The second tampering detection unit 502 compares the acquired prediction value of the transmission vehicle speed with the transmission vehicle speed (an actual measurement value) included in the logging data that has been received by the reception unit 501. Then, it is determined whether the difference between them falls within a threshold range (for example, within an optional numerical value % between 5% and 10%). In a case where the difference exceeds the threshold range, it is determined that the transmission vehicle speed (the actual measurement value) has been tampered with. In this situation, in the case where the difference exceeds the threshold range for a predetermined period of time or more continuously, it may be determined that the data has been tampered with. In a case where the difference exceeds the threshold range as an instantaneous value, there is also a possibility of erroneous detection. By determining whether the difference exceeds the threshold range for a predetermined period of time or more continuously, the erroneous detection can be suppressed.

In addition, the second tampering detection unit 502 inputs the respective values of the engine torque, the engine water temperature, and the accelerator pedal position, which are included in the evaluation data for evaluating the wheel speed, into the prediction model beforehand, and acquires a prediction value of the wheel speed. The second tampering detection unit 502 compares the acquired prediction value of the wheel speed with the wheel speed (an actual measurement value) included in the logging data that has been received by the reception unit 501, and determines whether a difference between them falls within a threshold range (for example, within an optional numerical value % between 5% and 10%). Then, in a case where the difference exceeds the threshold range, it is determined that the wheel speed (the actual measurement value) has been tampered with. In this situation, in the case where the difference exceeds the threshold range for a predetermined period of time or more continuously, it may be determined that the data has been tampered with. In a case where the difference exceeds the threshold range as the instantaneous value, there is a possibility of erroneous detection. By determining whether the difference exceeds the threshold range for a predetermined period of time or more continuously, the erroneous detection can be suppressed.

In the first tampering detection processing (the simple detection processing), only the difference between the transmission vehicle speed and the wheel speed is focused on. Hence, even though the tampering possibility can be detected, it is not possible to identify which vehicle data has been tampered with. On the other hand, by performing the second tampering detection processing (the detailed detection processing), it becomes possible to specifically identify which vehicle data of the transmission vehicle speed and the wheel speed has been tampered with.

Next, a case where the vehicle data includes the YAW angular velocity and its comparison values will be described. The second tampering detection unit 502 inputs the respective values of the steering torque, the steering angular velocity, and the accelerator pedal position, which are included in the evaluation data for evaluating the YAW angular velocity, into the prediction model beforehand, and acquires a prediction value of the YAW angular velocity. The second tampering detection unit 502 compares the acquired prediction value of the YAW angular velocity with the YAW angular velocity (an actual measurement value) included in the logging data that has been received by the reception unit 501. Then, it is determined whether the difference between them falls within a threshold range (for example, within an optional numerical value % between 5% and 10%). Then, in a case where the difference exceeds the threshold range, it is determined that the YAW angular velocity (the actual measurement value) has been tampered with. In this situation, in the case where the difference exceeds the threshold range for a predetermined period of time or more continuously, it may be determined that the data has been tampered with. In a case where the difference exceeds the threshold range as the instantaneous value, there is a possibility of erroneous detection. By determining whether the difference exceeds the threshold range for a predetermined period of time or more continuously, the erroneous detection can be suppressed.

In addition, according to the above-described equations (4) and (6), the vehicle data for calculating the comparison value 1 includes the wheel speed and the steering angle. That is, the vehicle data for evaluating the comparison value 1 includes vehicle data for evaluating the wheel speed and vehicle data for evaluating the steering angle. As illustrated in FIG. 11, the vehicle data for evaluating the wheel speed includes the engine torque, the engine water temperature, and the accelerator pedal position. In addition, the vehicle data for evaluating the steering angle includes the engine speed, the steering torque, and the engine water temperature.

The second tampering detection unit 502 inputs the respective values of the engine torque, the engine water temperature, and the accelerator pedal position, which are included in the vehicle data for evaluating the wheel speed, into the prediction model beforehand, and acquires a prediction value of the wheel speed. The second tampering detection unit 502 compares the acquired prediction value of the wheel speed with the wheel speed (an actual measurement value) included in the logging data that has been received by the reception unit 501, and determines whether a difference between them falls within a threshold range (for example, within an optional numerical value % between 5% and 10%).

Similarly, the second tampering detection unit 502 inputs the respective values of the engine speed, the steering torque, and the engine water temperature, which are included in the vehicle data for evaluating the steering angle, into the prediction model beforehand, and acquires a prediction value of the steering angle. The second tampering detection unit 502 compares the acquired prediction value of the steering angle with the steering angle (an actual measurement value) included in the logging data that has been received by the reception unit 501. Then, it is determined whether the difference between them falls within a threshold range (for example, within an optional numerical value % between 5% and 10%).

Then, in a case where at least one of the wheel speed and the steering angle exceeds the threshold range, the second tampering detection unit 502 may determine that the comparison value 1 has been tampered with. In addition, according to the above-described equations (5) and (6), the vehicle data for calculating the comparison value 2 includes the lateral acceleration and the steering angle. That is, the vehicle data for evaluating the comparison value 2 includes vehicle data for evaluating the acceleration in a left-and-right direction (the lateral acceleration) of the vehicle V and vehicle data for evaluating the steering angle. As illustrated in FIG. 11, the vehicle data for evaluating the acceleration in the left-and-right direction of the vehicle includes the steering torque, the steering angular velocity, and the axle torque. The vehicle data for evaluating the steering angle includes the engine speed, the steering torque, and the engine water temperature.

The second tampering detection unit 502 inputs the respective values of the steering torque, the steering angular velocity, and the axle torque, which are included in the vehicle data for evaluating the lateral acceleration, into the prediction model beforehand, and acquires a prediction value of the lateral acceleration. The second tampering detection unit 502 compares the acquired prediction value of the lateral acceleration with the lateral acceleration (an actual measurement value) included in the logging data that has been received by the reception unit 501, and determines whether a difference between them falls within a threshold range (for example, within an optional numerical value % between 5% and 10%).

Similarly, the second tampering detection unit 502 inputs the respective values of the engine speed, the steering torque, and the engine water temperature, which are included in the vehicle data for evaluating the steering angle, into the prediction model beforehand, and acquires a prediction value of the steering angle. The second tampering detection unit 502 compares the acquired prediction value of the steering angle with the steering angle (an actual measurement value) included in the logging data that has been received by the reception unit 501. Then, it is determined whether the difference between them falls within a threshold range (for example, within an optional numerical value % between 5% and 10%).

Then, in a case where at least one of the lateral acceleration and the steering angle exceeds the threshold range, the second tampering detection unit 502 may determine that the comparison value 2 has been tampered with. For example, in a case where it is determined that neither the comparison value 1 nor the comparison value 2 has been tampered with, and the YAW angular velocity has been tampered with, the second tampering detection unit 502 may determine that the YAW angular velocity has been tampered with. Alternatively, without being limited to the tampering possibility of the comparison value 1 or the comparison value 2, in a case where it is determined that the YAW angular velocity has been tampered with, the second tampering detection unit 502 may determine that the YAW angular velocity has been tampered with.

Furthermore, a case where the vehicle data includes the motor regenerative torque allocation value and the motor regenerative torque allocatable upper limit value will be described. The second tampering detection unit 502 inputs the respective values of the front-and-rear direction acceleration, the braking force of the brake, and the engine speed, which are included in the evaluation data for evaluating the motor regenerative torque allocation value, into the prediction model beforehand, and acquires a prediction value of the motor regenerative torque allocation value. The second tampering detection unit 502 compares the acquired prediction value of the motor regenerative torque allocation value with the motor regenerative torque allocation value (an actual measurement value) included in the logging data that has been received by the reception unit 501. Then, it is determined whether the difference between them falls within a threshold range (for example, within an optional numerical value % between 5% and 10%). Then, in a case where the difference exceeds the threshold range, it is determined that the motor regenerative torque allocation value (the actual measurement value) has been tampered with. In this situation, in the case where the difference exceeds the threshold range for a predetermined period of time or more continuously, it may be determined that the data has been tampered with. In a case where the difference exceeds the threshold range as the instantaneous value, there is a possibility of erroneous detection. By determining whether the difference exceeds the threshold range for a predetermined period of time or more continuously, the erroneous detection can be suppressed.

Similarly, the second tampering detection unit 502 inputs the respective values of the front-and-rear direction acceleration, the braking force of the brake, and the engine water temperature, which are included in the evaluation data for evaluating the motor regenerative torque allocatable upper limit, into the prediction model beforehand, and acquires a prediction value of the motor regenerative torque allocatable upper limit. The second tampering detection unit 502 compares the acquired prediction value of the motor regenerative torque allocatable upper limit value with the motor regenerative torque allocatable upper limit value (an actual measurement value) included in the logging data that has been received by the reception unit 501. Then, it is determined whether the difference between them falls within a threshold range (for example, within an optional numerical value % between 5% and 10%). Then, in a case where the difference exceeds the threshold range, it is determined that the motor regenerative torque allocatable upper limit value (the actual measurement value) has been tampered with. In this situation, in the case where the difference exceeds the threshold range for a predetermined period of time or more continuously, it may be determined that the data has been tampered with. In a case where the difference exceeds the threshold range as the instantaneous value, there is a possibility of erroneous detection. By determining whether the difference exceeds the threshold range for a predetermined period of time or more continuously, the erroneous detection can be suppressed.

Each prediction model in the above description is a model prepared beforehand for every combination of the evaluation data that serves as input data. For example, a machine-learned model is used for the prediction model.

### <Processing Sequence of Information Processing System>

Next, processing of the information processing system according to one embodiment will be described with reference to a processing sequence of FIG. 6. In F601, the vehicle data acquisition unit 401 of the control device CNT of the vehicle V acquires various types of the vehicle data that have been measured and/or calculated in the vehicle V. The vehicle data is acquired over time (for example, at predetermined time intervals). In F602, the first tampering detection unit 402 of the control device CNT of the vehicle V detects a tampering possibility of the vehicle data, based on two pieces of the vehicle data, by using the vehicle data that has been acquired by the vehicle data acquisition unit 401 in F601 (simple detection).

In F603, in a case where the first tampering detection unit 402 detects that there is the tampering possibility in F602, the transmission unit 403 of the control device CNT of the vehicle V transmits the logging data of the vehicle V to the information processing apparatus 20. The logging data includes the vehicle data and the evaluation data for evaluating the vehicle data. The logging data may be data acquired over a certain time range from the time when the tampering possibility is detected.

In F604, the second tampering detection unit 502 detects tampering of the vehicle data, based on the evaluation data included in the logging data that has been received by the reception unit 501 and the prediction model (detailed detection). In addition, which vehicle data has been tampered with is identified.

In F605, when the tampering is detected, the notification unit 503 notifies the second tampering detection unit 502 of a detection result. For example, the user is notified of an occurrence of the tampering, or is notified of information about the vehicle data that has been tampered with. The notification unit 503 may give a notification via the display unit 204 of the information processing apparatus 20, may give a notification in the form of a warning by sound, or may give a notification in combination of them. In addition, the notification unit 503 may transmit a warning to the vehicle V, and the vehicle V may notify of an occurrence of tampering (display and/or output a warning sound). Furthermore, the notification unit 503 may prompt the user to contact the car dealer or the like of the vehicle V. Heretofore, the processing sequence of FIG. 6 ends.

As described heretofore, in the present embodiment, the simple detection processing of detecting the tampering possibility of the vehicle data is performed, based on the comparison between two pieces of the vehicle data. Then, in a case where it is determined that there is a tampering possibility, the detailed detection processing of detecting the tampering of the vehicle data is performed, based on the evaluation data for evaluating the vehicle data.

In this manner, by detecting the tampering possibility in simple and low-load processing, and by performing detailed and high-load processing only in a case where there is the tampering possibility, it becomes possible to reduce the processing load at the normal time with a low tampering possibility.

In addition, the simple tampering detection processing is performed in the vehicle V. In a case where the tampering possibility is detected, the logging data is acquired and transmitted to the information processing apparatus in the outside, and the information processing apparatus in the outside performs the detailed tampering detection processing. This enables a reduction in the processing load of the vehicle V. Therefore, the resources of the vehicle V can be effectively used for another processing.

In addition, even though a large change in value occurs within a design value range that cannot be found by the normal failure detection, it becomes possible to detect the tampering.

### [Modifications]

In the above embodiments, an example in which the control device CNT of the vehicle V performs the simple tampering detection processing and the information processing apparatus 20 performs the detailed tampering detection processing has been described, but the present invention is not limited to this example. The control device CNT of the vehicle V may be configured to perform both processing. Alternatively, data may be transmitted from the vehicle V to the information processing apparatus 20 over time, and the information processing apparatus 20 may perform both processing. That is, in the information processing system 10, (the control device CNT of) the vehicle V or the information processing apparatus 20 is capable of operating solely.

In the above embodiments, some examples have been described as the vehicle data and the evaluation data for evaluating the vehicle data, but the present invention is not limited to these examples. Any vehicle data may be applied as long as the physical quantities of two pieces of the vehicle data are identical in type to each other. In addition, any evaluation data may be applied as long as the vehicle data can be evaluated.

Further, in the above-described embodiments, an example in which the notification unit 503 gives a notification when the second tampering detection unit 502 detects the tampering has been described. The vehicle V may give a notification when the first tampering detection unit 402 detects the tampering possibility. Information indicating tampering suspicion may be notified by display and/or sound. Furthermore, transmission of the logging data to the information processing apparatus 20 may also be notified. Accordingly, the user of the vehicle Vis able to easily recognize that there is a tampering possibility while the user is in the vehicle.

In addition, in the above embodiments, the four-wheeled vehicle has been mainly described as an example of the vehicle, but the present invention is applicable to any moving bodies, such as two-wheeled vehicles, two-leg walking robots, four-leg walking robots, and drones, in addition to the four-wheeled vehicles. Further, in the above embodiments, the description has been mainly given by taking the vehicle as an example, but the vehicle may include all moving bodies, such as drones and robots.

### Summary of Embodiments

1. The information processing system according to the above embodiments is an information processing system (10) configured to detect tampering of vehicle data, the information processing system comprising:
a vehicle data acquisition unit (401) configured to acquire first vehicle data and second vehicle data;
a first tampering detection unit (402) configured to detect a tampering possibility of the vehicle data, based on the first vehicle data and the second vehicle data; and
a second tampering detection unit (502) configured to detect tampering of the first vehicle data, based on first evaluation data for evaluating the first vehicle data, and also configured to detect tampering of the second vehicle data, based on second evaluation data for evaluating the second vehicle data, in a case where the first tampering detection unit detects that there is the tampering possibility.

In this manner, by performing simple tampering detection processing based on simple data comparison, and by performing more detailed tampering detection processing in a case where there is a tampering possibility, it becomes possible to accurately detect tampering of the vehicle data while reducing the processing load.

2. The information processing system according to the above embodiments, wherein a physical quantity of the first vehicle data is identical in type to a physical quantity of the second vehicle data.

Thus, it becomes possible to easily compare two pieces of the vehicle data.

3. The information processing system according to the above embodiments, wherein a physical quantity of the first vehicle data is different in type from a physical quantity of the first evaluation data.

In this manner, by using the physical quantity different in type from the vehicle data, as the evaluation data, it becomes possible to indirectly determine whether the vehicle data has been tampered with.

4. The information processing system according to the above embodiments, wherein a physical quantity of the second vehicle data is different in type from a physical quantity of the second evaluation data.

In this manner, by using the physical quantity different in type from the vehicle data, as the evaluation data, it becomes possible to indirectly determine whether the vehicle data has been tampered with.

5. The information processing system according to the above embodiments, wherein
the second tampering detection unit is configured to:
   detect tampering of the first vehicle data, based on the first evaluation data and a first prediction model; and
   detect tampering of the second vehicle data, based on the second evaluation data and a second prediction model.

Accordingly, a prediction value of the vehicle data is obtained by inputting the evaluation data into the prediction model, and the prediction value is compared with an actual measurement value of the vehicle data, and thus it becomes possible to determine whether the vehicle data has been tampered with.

6. The information processing system according to the above embodiments, wherein
the first vehicle data includes a transmission vehicle speed, and
the second vehicle data includes a wheel speed.

Accordingly, by acquiring two different types of vehicle speed data and comparing them, it becomes possible to detect the tampering possibility of the vehicle speed data.

7. The information processing system according to the above embodiments, wherein the first evaluation data is vehicle data for evaluating the transmission vehicle speed.

This makes it possible to determine whether the transmission vehicle speed has been tampered with.

8. The information processing system according to the above embodiments, wherein the vehicle data for evaluating the transmission vehicle speed includes engine torque, an engine water temperature, and axle torque.

This makes it possible to determine whether the transmission vehicle speed has been tampered with.

9. The information processing system according to the above embodiments, wherein the second evaluation data is vehicle data for evaluating the wheel speed.

This makes it possible to determine whether the wheel speed has been tampered with.

10. The information processing system according to the above embodiments, wherein the vehicle data for evaluating the wheel speed includes engine torque, an engine water temperature, and an accelerator pedal position.

This makes it possible to determine whether the wheel speed has been tampered with.

11. The information processing system according to the above embodiments, wherein
the first vehicle data includes a YAW angular velocity, and
the second vehicle data includes a first comparison value of the YAW angular velocity based on a wheel speed and a steering angle, and a second comparison value of the YAW angular velocity based on acceleration in a left-and-right direction of a vehicle and the steering angle.

Accordingly, by using a set of the YAW angular velocity and the first comparison value and a set of the YAW angular velocity and the second comparison value, it becomes possible to detect the tampering possibility of the YAW angular velocity or each comparison value.

12. The information processing system according to the above embodiments, wherein the first evaluation data is vehicle data for evaluating the YAW angular velocity.

This makes it possible to determine whether the YAW angular velocity has been tampered with.

13. The information processing system according to the above embodiments, wherein the vehicle data for evaluating the YAW angular velocity includes steering torque, a steering angular velocity, and an accelerator pedal position.

This makes it possible to determine whether the YAW angular velocity has been tampered with.

14. The information processing system according to the above embodiments, wherein the second evaluation data is vehicle data for evaluating the first comparison value and the second comparison value.

This makes it possible to determine whether the comparison value has been tampered with.

15. The information processing system according to the above embodiments, wherein the vehicle data for evaluating the first comparison value includes vehicle data for evaluating the wheel speed, and vehicle data for evaluating the steering angle.

This makes it possible to determine whether the comparison value of the YAW angular velocity based on the wheel speed and the steering angle has been tampered with.

16. The information processing system according to the above embodiments, wherein the vehicle data for evaluating the wheel speed includes engine torque, an engine water temperature, and an accelerator pedal position.

This makes it possible to determine whether the wheel speed has been tampered with.

17. The information processing system according to the above embodiments, wherein the vehicle data for evaluating the steering angle includes an engine speed, steering torque, and an engine water temperature.

This makes it possible to determine whether the steering angle has been tampered with.

18. The information processing system according to the above embodiments, wherein vehicle data for evaluating the second comparison value includes vehicle data for evaluating the acceleration in the left-and-right direction of the vehicle, and vehicle data for evaluating the steering angle.

This makes it possible to determine whether another comparison value of the YAW angular velocity based on the lateral acceleration and the steering angle has been tampered with.

19. The information processing system according to the above embodiments, wherein the vehicle data for evaluating the acceleration in the left-and-right direction of the vehicle includes steering torque, a steering angular velocity, and axle torque.

This makes it possible to determine whether the lateral acceleration has been tampered with.

20. The information processing system according to the above embodiments, wherein the vehicle data for evaluating the steering angle includes an engine speed, steering torque, and an engine water temperature.

This makes it possible to determine whether the steering angle has been tampered with.

21. The information processing system according to the above embodiments, wherein
the first vehicle data includes a motor regenerative torque allocation value,
the second vehicle data includes a motor regenerative torque allocatable upper limit value,
the motor regenerative torque allocation value is torque for subtracting torque corresponding to regeneration of a motor from brake, and
the motor regenerative torque allocatable upper limit value is torque that can subtract braking torque from a brake.

Accordingly, by comparing the motor regenerative torque allocation value with the motor regenerative torque allocatable upper limit value, it becomes possible to detect the tampering possibility of the motor regenerative torque allocation value.

22. The information processing system according to the above embodiments, wherein vehicle data for evaluating the motor regenerative torque allocation value includes acceleration in a front-and-rear direction of a vehicle, braking force of a brake, and an engine speed.

This makes it possible to determine whether the motor regenerative torque allocation value has been tampered with.

23. The information processing system according to the above embodiments, wherein vehicle data for evaluating the motor regenerative torque allocatable upper limit value includes acceleration in a front-and-rear direction of a vehicle, braking force of a brake, and an engine water temperature.

This makes it possible to determine whether the motor regenerative torque allocatable upper limit value has been tampered with.

24. The information processing system according to the above embodiments, further comprising a notification unit configured to give a notification, based on a detection result of the second tampering detection unit.

This enables the user (the user of the vehicle and/or the user of the information processing apparatus) to recognize an occurrence of tampering of the vehicle data.

25. The control method of an information processing system according to the above embodiments is a control method of an information processing system configured to detect tampering of vehicle data, the control method comprising:
acquiring first vehicle data and second vehicle data;
detecting a tampering possibility of the vehicle data, based on the first vehicle data and the second vehicle data; and
detecting tampering of the first vehicle data, based on first evaluation data for evaluating the first vehicle data, and also detecting tampering of the second vehicle data, based on second evaluation data for evaluating the second vehicle data, in a case where the tampering possibility is detected.

In this manner, by performing simple tampering detection processing based on simple data comparison, and by performing more detailed tampering detection processing in a case where there is a tampering possibility, it becomes possible to accurately detect tampering of the vehicle data while reducing the processing load.

26. The information processing system according to the above embodiments is an information processing system (10) comprising: a vehicle (V); and an information processing apparatus (20), the information processing system being configured to detect tampering of vehicle data, wherein
the vehicle includes:
   a vehicle data acquisition unit (401) configured to acquire first vehicle data and second vehicle data;
   a first tampering detection unit (402) configured to detect a tampering possibility of the vehicle data, based on the first vehicle data and the second vehicle data; and
   a transmission unit (403) configured to transmit logging data of the vehicle to the information processing apparatus, in a case where the tampering possibility is detected, the logging data including the first vehicle data, the second vehicle data, first evaluation data for evaluating the first vehicle data, and second evaluation data for evaluating the second vehicle data, and
the information processing apparatus includes:
   a reception unit (501) configured to receive the logging data from the vehicle; and
   a second tampering detection unit (502) configured to detect tampering of the first vehicle data, based on the first evaluation data, and also configured to detect tampering of the second vehicle data, based on the second evaluation data, upon receipt of the logging data.

In this manner, by performing the simple tampering detection processing based on simple data comparison in the vehicle, and by performing the more detailed tampering detection processing in the information processing apparatus different from the vehicle in a case where there is a tampering possibility, it becomes possible to accurately detect tampering of the vehicle data while reducing the processing load of the vehicle.

27. The control method of an information processing system is a control method of an information processing system (10) including a vehicle (V) and an information processing apparatus (20), the information processing system being configured to detect tampering of vehicle data, the control method comprising:
Acquiring (F601), by the vehicle, first vehicle data and second vehicle data;
detecting (F602), by the vehicle, a tampering possibility of the vehicle data, based on the first vehicle data and the second vehicle data;
transmitting (F603), by the vehicle, logging data of the vehicle to the information processing apparatus, in a case where the tampering possibility is detected, the logging data including the first vehicle data, the second vehicle data, first evaluation data for evaluating the first vehicle data, and second evaluation data for evaluating the second vehicle data;
receiving (F603), by the information processing apparatus, the logging data from the vehicle; and
detecting (F604), by the information processing apparatus, tampering of the first vehicle data, based on the first evaluation data, and also detecting tampering of the second vehicle data, based on the second evaluation data, upon receipt of the logging data.

In this manner, by performing the simple tampering detection processing based on simple data comparison in the vehicle, and by performing the more detailed tampering detection processing in the information processing apparatus different from the vehicle in a case where there is a tampering possibility, it becomes possible to accurately detect tampering of the vehicle data while reducing the processing load of the vehicle.

28. The program according to the above embodiments is a program for causing a computer to function as the information processing system according to the above embodiments.

This enables the processing according to the above embodiments to be achieved by a program.

29. The storage medium according to the above embodiments is a storage medium storing a program for causing a computer to function as the information processing system according to the above embodiments.

This enables the processing according to the above embodiments to be achieved by the storage medium.

### Other Embodiments

In addition, a program for achieving one or more functions that have been described in each of the embodiments is supplied to a system or an apparatus through a network or via a storage medium, and one or more processors on a computer of the system or the apparatus are capable of reading and executing the program. The present invention can also be achieved according to such an aspect.

According to the present invention, tampering of the vehicle data can be accurately detected.

The invention is not limited to the foregoing embodiments, and various variations/changes are possible within the spirit of the invention.

What is claimed is:

1. An information processing system configured to detect tampering of vehicle data, the information processing system comprising:
a vehicle data acquisition unit configured to acquire first vehicle data and second vehicle data;
a first tampering detection unit configured to detect a tampering possibility of the vehicle data, based on the first vehicle data and the second vehicle data; and
a second tampering detection unit configured to detect tampering of the first vehicle data, based on first evaluation data for evaluating the first vehicle data, and also configured to detect tampering of the second vehicle data, based on second evaluation data for evaluating the second vehicle data, in a case where the first tampering detection unit detects that there is the tampering possibility.

2. The information processing system according to claim 1, wherein a physical quantity of the first vehicle data is identical in type to a physical quantity of the second vehicle data.

3. The information processing system according to claim 1, wherein a physical quantity of the first vehicle data is different in type from a physical quantity of the first evaluation data.

4. The information processing system according to claim 1, wherein a physical quantity of the second vehicle data is different in type from a physical quantity of the second evaluation data.

5. The information processing system according to claim 1, wherein
the second tampering detection unit is configured to:
detect tampering of the first vehicle data, based on the first evaluation data and a first prediction model; and
detect tampering of the second vehicle data, based on the second evaluation data and a second prediction model.

6. The information processing system according to claim 1, wherein
the first vehicle data includes a transmission vehicle speed, and
the second vehicle data includes a wheel speed.

7. The information processing system according to claim 6, wherein the first evaluation data is vehicle data for evaluating the transmission vehicle speed.

8. The information processing system according to claim 7, wherein the vehicle data for evaluating the transmission vehicle speed includes engine torque, an engine water temperature, and axle torque.

9. The information processing system according to claim 6, wherein the second evaluation data is vehicle data for evaluating the wheel speed.

10. The information processing system according to claim 9, wherein the vehicle data for evaluating the wheel speed includes engine torque, an engine water temperature, and an accelerator pedal position.

11. The information processing system according to claim 1, wherein
the first vehicle data includes a YAW angular velocity, and
the second vehicle data includes a first comparison value of the YAW angular velocity based on a wheel speed and a steering angle, and a second comparison value of the YAW angular velocity based on acceleration in a left-and-right direction of a vehicle and the steering angle.

12. The information processing system according to claim 11, wherein the first evaluation data is vehicle data for evaluating the YAW angular velocity.

13. The information processing system according to claim 12, wherein the vehicle data for evaluating the YAW angular velocity includes steering torque, a steering angular velocity, and an accelerator pedal position.

14. The information processing system according to claim 11, wherein the second evaluation data is vehicle data for evaluating the first comparison value and the second comparison value.

15. The information processing system according to claim 14, wherein the vehicle data for evaluating the first comparison value includes vehicle data for evaluating the wheel speed, and vehicle data for evaluating the steering angle.

16. The information processing system according to claim 15, wherein the vehicle data for evaluating the wheel speed includes engine torque, an engine water temperature, and an accelerator pedal position.

17. The information processing system according to claim 15, wherein the vehicle data for evaluating the steering angle includes an engine speed, steering torque, and an engine water temperature.

18. The information processing system according to claim 14, wherein vehicle data for evaluating the second comparison value includes vehicle data for evaluating the acceleration in the left-and-right direction of the vehicle, and vehicle data for evaluating the steering angle.

19. The information processing system according to claim 18, wherein the vehicle data for evaluating the acceleration in the left-and-right direction of the vehicle includes steering torque, a steering angular velocity, and axle torque.

20. The information processing system according to claim 18, wherein the vehicle data for evaluating the steering angle includes an engine speed, steering torque, and an engine water temperature.

21. The information processing system according to claim 1, wherein
the first vehicle data includes a motor regenerative torque allocation value,
the second vehicle data includes a motor regenerative torque allocatable upper limit value,
the motor regenerative torque allocation value is torque for subtracting torque corresponding to regeneration of a motor from brake, and
the motor regenerative torque allocatable upper limit value is torque that can subtract braking torque from a brake.

22. The information processing system according to claim 21, wherein vehicle data for evaluating the motor regenerative torque allocation value includes acceleration in a front-and-rear direction of a vehicle, braking force of a brake, and an engine speed.

23. The information processing system according to claim 21, wherein vehicle data for evaluating the motor regenerative torque allocatable upper limit value includes acceleration in a front-and-rear direction of a vehicle, braking force of a brake, and an engine water temperature.

24. The information processing system according to claim 1, further comprising a notification unit configured to give a notification, based on a detection result of the second tampering detection unit.

25. A control method of an information processing system configured to detect tampering of vehicle data, the control method comprising:
acquiring first vehicle data and second vehicle data;
detecting a tampering possibility of the vehicle data, based on the first vehicle data and the second vehicle data; and
detecting tampering of the first vehicle data, based on first evaluation data for evaluating the first vehicle data, and also detecting tampering of the second vehicle data, based on second evaluation data for evaluating the second vehicle data, in a case where the tampering possibility is detected.

26. An information processing system comprising: a vehicle; and an information processing apparatus, the information processing system being configured to detect tampering of vehicle data, wherein
the vehicle includes:
a vehicle data acquisition unit configured to acquire first vehicle data and second vehicle data;
a first tampering detection unit configured to detect a tampering possibility of the vehicle data, based on the first vehicle data and the second vehicle data; and
a transmission unit configured to transmit logging data of the vehicle to the information processing apparatus, in a case where the tampering possibility is detected, the logging data including the first vehicle data, the second vehicle data, first evaluation data for evaluating the first vehicle data, and second evaluation data for evaluating the second vehicle data, and
the information processing apparatus includes:
a reception unit configured to receive the logging data from the vehicle; and
a second tampering detection unit configured to detect tampering of the first vehicle data, based on the first evaluation data, and also configured to detect tampering of the second vehicle data, based on the second evaluation data, upon receipt of the logging data.

27. A control method of an information processing system including a vehicle and an information processing apparatus, the information processing system being configured to detect tampering of vehicle data, the control method comprising:
acquiring, by the vehicle, first vehicle data and second vehicle data;
detecting, by the vehicle, a tampering possibility of the vehicle data, based on the first vehicle data and the second vehicle data;
transmitting, by the vehicle, logging data of the vehicle to the information processing apparatus, in a case where the tampering possibility is detected, the logging data including the first vehicle data, the second vehicle data, first evaluation data for evaluating the first vehicle data, and second evaluation data for evaluating the second vehicle data;
receiving, by the information processing apparatus, the logging data from the vehicle; and
detecting, by the information processing apparatus, tampering of the first vehicle data, based on the first evaluation data, and also detecting tampering of the second vehicle data, based on the second evaluation data, upon receipt of the logging data.

28. A non-transitory computer-readable storage medium storing a program for causing a computer to function as the information processing system according to claim 1.
